(19) United States
(12) Patent Application Publication
(10) Pub. No.: US 2008/0198340 A1
(43) Pub. Date: Aug. 21, 2008

(54) IMAGING MODULE

(75) Inventors: Wen-Wei Tsai, Hsinchu (TW); Cheng-Kuei Chen, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: CORETRONIC CORPORATION, Hsinchu (TW)

(21) Appl. No.: 11/845,748

(22) Filed: Aug. 27, 2007

(30) Foreign Application Priority Data
Feb. 16, 2007 (TW) 96106088

(51) Int. Cl. G02B 7/02

(52) U.S. Cl. 353/100

(57) ABSTRACT

An imaging module includes a first housing, a projection lens, elastic members and lock members. The first housing has a first combination part having first lock holes. The projection lens has a lens barrel and at least one lens disposed inside the lens barrel. The lens barrel has a plurality of connection parts extending outward. Each connection part has a second lock hole. The elastic members are disposed between each connection part and the first combination part. Each elastic member has a first surface leant against the corresponding connection part and a second surface leant against the first combination part. The first surfaces form a first datum plane. The connection parts lean against the first datum plane. Each lock member is inserted into the corresponding second lock hole, the corresponding first lock hole and the elastic member between the corresponding second lock hole and first lock hole.

### CROSS-REFERENCE TO RELATED APPLICATION

This application claims the priority benefit of Taiwan application serial no. 96106088, filed Feb. 16, 2007. All disclosure of the Taiwan application is incorporated herein by reference.

### BACKGROUND OF THE INVENTION

1. Field of the Invention

The present invention relates to a display device. More particularly, the present invention relates to a projection device and an imaging module thereof.

2. Description of Related Art

Referring to FIG. 1, FIG. 2A and FIG. 2B, a conventional imaging module 100 is suitable for a projection device (not shown). The imaging module 100 includes a housing 110, a projection lens 120 and a plurality of screws 130. The housing 110 has a first combination part 112 and a second combination part 114. The first combination part 112 has a plurality of first lock holes 112a and a plurality of first ribs 112b disposed around the first lock holes 112a, and The top surfaces of the first ribs 112b form a first datum plane 112c. Moreover, the second combination part 114 has a plurality of (for example: three) second ribs 114a, and the top surfaces of the second ribs 114a form a second datum plane 114b.

The projection lens 120 includes a lens barrel 122 and a plurality of lens 124 (only one is shown in FIG. 1) disposed inside the lens barrel 122. The lens barrel 122 has a plurality of connection parts 123 extending outward and leaning against the first datum plane 112c. Each connection part 123 has a second lock hole 123a, and each second lock hole 123a respectively corresponds to one of the first lock holes 112a. Moreover, each screw 130 is inserted into the corresponding second lock hole 123a and first lock hole 112a for fixing the projection lens 120 on the housing 110.

In addition, the second datum plane 114b is suitable for a DMD 200 of the projection device to lean against. The DMD 200 is suitable for converting an illumination beam into an image beam, and for reflecting the image beam to the projection lens 120. The projection lens 120 projects the image beam to a screen to form an image on the screen.

It is noticeable that the normal vector of an active surface 202 of the DMD 200 needs to be parallel to an optical axis of the projection lens 120, such that the first datum plane 112c is parallel to the second datum plane 114b accordingly for maintaining a good image quality. However, heights of the first ribs 112b and heights of the second ribs 114a are usually not identical to each other due to the manufacturing tolerance. Thus, the first datum plane 112c is not parallel to the second datum plane 114b. Moreover, accumulation of the tolerance is inevitable during the process of fixing the projection lens 120 and the DMD 200 on the housing 110. Thus, the normal vector of the active surface 202 of the DMD 200 is not parallel to the optical axis of the projection lens 120, and accordingly, causes poor image focusing and poor image quality.

### SUMMARY OF THE INVENTION

One object of the present invention is directed to provide an image module for improving image quality.

Another object of the present invention is directed to provide a projection device for improving image quality.

To achieve one, some or all of the above-mentioned or other objects, one embodiment of the present invention provides an imaging module including a first housing, a projection lens, a plurality of elastic members and a plurality of lock members. The first housing has a first combination part, the first combination part has a plurality of first lock holes. The projection lens has a lens barrel and at least one lens disposed inside the lens barrel, and the lens barrel has a plurality of connection parts extending outward. Each connection part has a second lock hole, and each second lock hole respectively corresponds to one of the first lock holes. Furthermore, the elastic members are disposed between each connection part and the first combination part. Each elastic member has a first surface and a second surface opposite to the first surface, and the first surface is leant against the corresponding connection part, and the second surface is leant against the first combination part. The first surfaces form a first datum plane and the connection parts are leant against the first datum plane. Each lock member is inserted into the corresponding second lock hole and first lock hole and the elastic member between the corresponding second lock hole and first lock hole.

Another embodiment of the present invention provides another imaging module including a first housing, a projection lens, a plurality of first lock members, a plurality of elastic members and a plurality of second lock members. The first housing has a first combination part; the first combination part has a first datum plane and a plurality of first lock holes. The projection lens has a lens barrel and at least one lens disposed inside the lens barrel, and the lens barrel has a plurality of connection parts extending outward. Each connection part has a second lock hole and a third lock hole, and each second lock hole respectively corresponds to one of the first lock holes. Each first lock member is inserted into the corresponding second lock hole and first lock hole, and is locked in the corresponding first lock hole. Each first lock member is respectively inserted into one of the elastic members, and each elastic member is leant against one end of the corresponding first lock member and against the corresponding connection part. The second lock members respectively inserted into the third lock holes, and each second lock member is leant against the first combination part.

In the first imaging module of the present invention, the elastic members are disposed between each connection part of the lens barrel and the first combination part of the first housing, such that an optical axis of the projection lens is rendered substantially parallel to the normal vector of an active surface of the display device by adjusting the tension of the lock members, and thus, the image quality is improved. Moreover, in the second imaging module of the present invention, the optical axis of the projection lens is rendered substantially parallel to the normal vector of an active surface of the display device by moving the connection parts by turning the second lock members in the clockwise or anticlockwise direction, and thus, the image quality is improved.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is an exploded view of a conventional imaging module and a perspective view of a digital micro-mirror device (DMD).

FIG. 2A is a perspective view of a housing of FIG. 1.

FIG. 2B is a side view of the housing of FIG. 1.

FIG. 3 is an exploded view of an imaging module and a perspective view of a display device according to an embodiment of the present invention.

FIG. 4A is an exploded view of the imaging module of FIG. 3.

FIG. 4B is a side view of a first housing of FIG. 3.

FIG. 5 is a perspective view of the first housing of FIG. 3.

FIG. 6A is a diagram of the combined imaging module and display device of FIG. 3.

FIG. 6B is a diagram of the adjusted imaging module and display device of FIG. 6A.

FIG. 7A is a perspective view of a projection device according to an embodiment of the present invention.

FIG. 7B is a partial exploded view of the projection device of FIG. 7A.

FIG. 8 is a diagram of an imaging module according to another embodiment of the present invention.

FIG. 9A is a diagram of the imaging module of FIG. 8 when first lock members and second lock members are loosened.

FIG. 9B is a diagram of a first housing of FIG. 8.

FIG. 10 is another perspective view of the first housing of FIG. 8.

FIG. 11 is a diagram of the adjusted imaging module of FIG. 8.

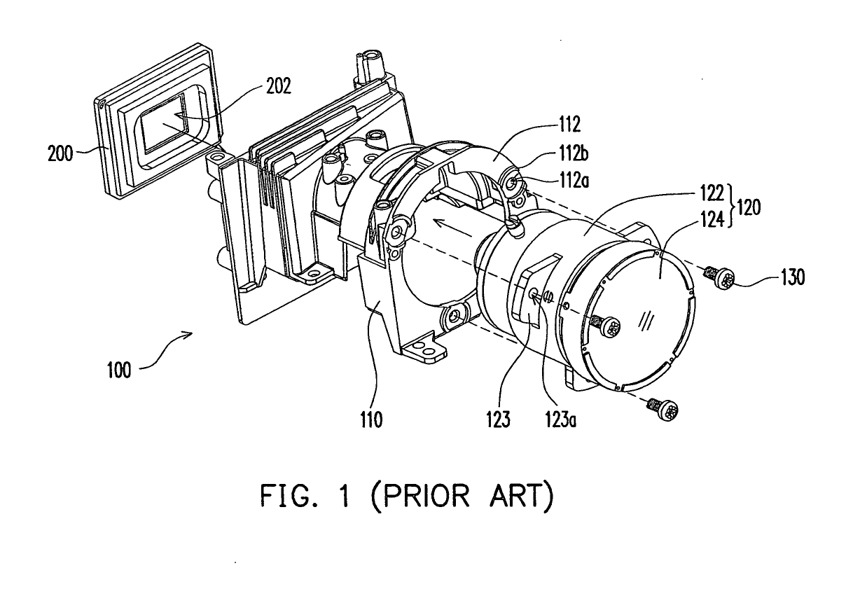

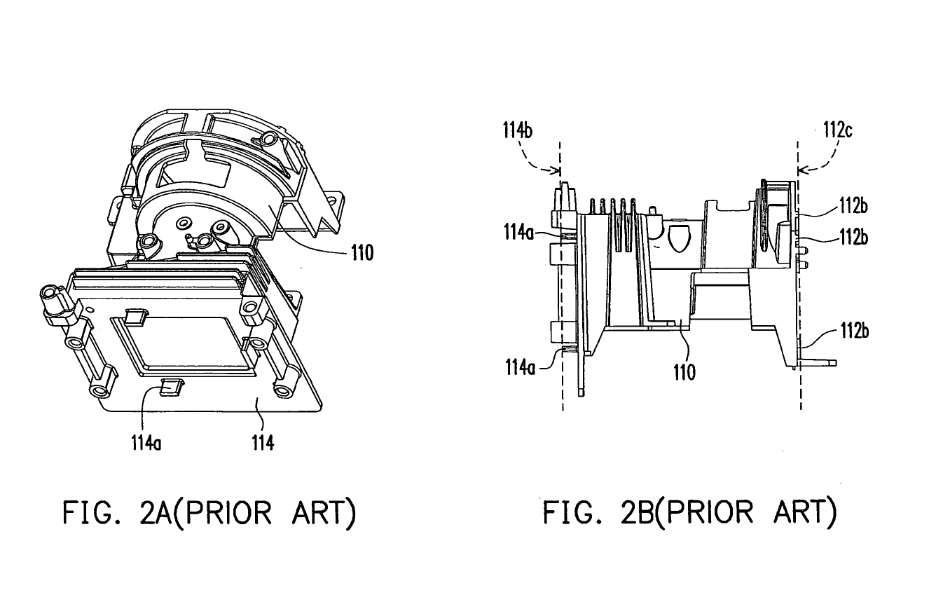

### DESCRIPTION OF EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

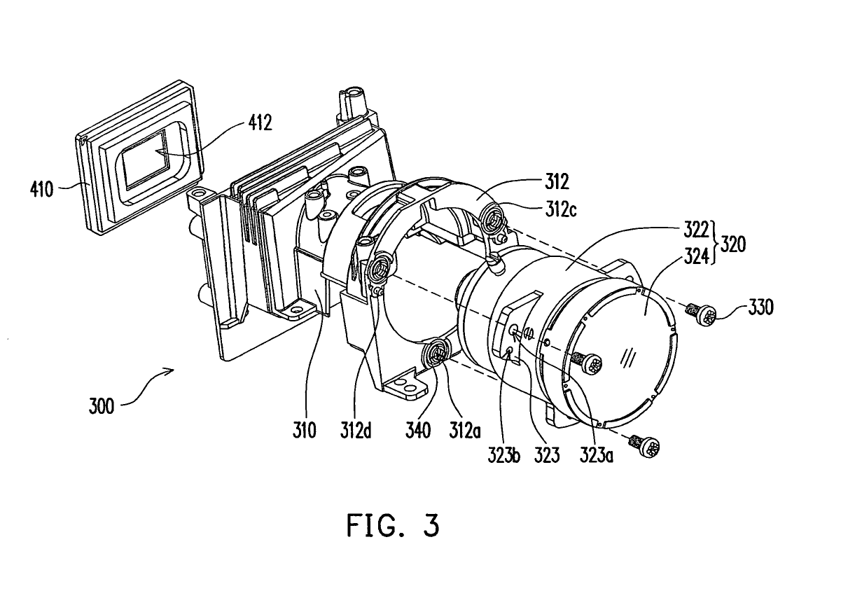

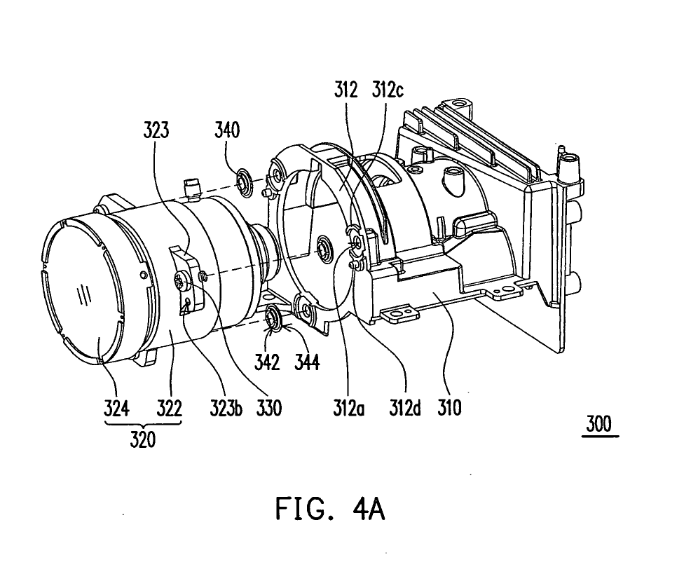

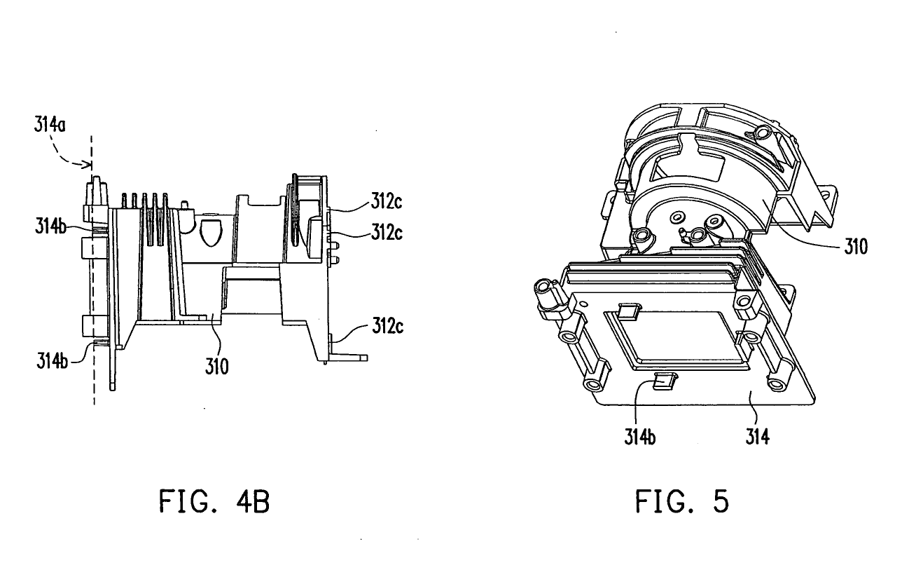

Referring to FIG. 3, FIG. 4A and FIG. 4B, an imaging module 300 according to one embodiment of the present invention includes a first housing 310, a projection lens 320, a plurality of lock members 330 and a plurality of elastic members 340. The lock members 330 are used for locking the projection lens 320 and the elastic members 340 on the first housing 310, and the elastic members 340 are disposed between the projection lens 320 and the first housing 310.

The first housing 310 has a first combination part 312, and the first combination part 312 has a plurality of first lock holes 312a. The first combination part 312 has, for example, a plurality of first ribs 312c formed thereon and disposed around the first lock holes 312a. Moreover, in the present embodiment, the shape of the first combination part 312 is substantially a ring. The number of the first lock holes 312a is three, and an angle between two adjacent first lock holes 312a is approximately 120 degree. In addition, the projection lens 320 has a lens barrel 322 and at least one lens 324 disposed inside the lens barrel 322, and the lens barrel 322 has a plurality of connection parts 323 extending outward. Each connection part 323 has a second lock hole 323a, and each second lock hole 323a respectively corresponds to one of the first lock holes 312a. In the present embodiment, the numbers of the connection parts 323 and the elastic members 340 are respectively three, and an angle between two adjacent connection parts 323 is 120 degree.

The aforementioned elastic members 340 are disposed between each connection part 323 and the first combination part 312. Each elastic member 340 has a first surface 342 and a second surface 344 opposite to the first surface 342. The first surface 342 is leaned against the corresponding connection part 323, and the second surface 344 is leaned against the first combination part 312. The first surfaces 342 of the elastic members 340 form a first datum plane and the connection parts 323 are leaned against the first datum plane. Each lock member 330 is inserted into the corresponding second lock hole 323a, the first lock hole 312a and the elastic member 340 between the corresponding second lock hole 323a and first lock hole 312a, and therefore locks the projection lens 320 and the elastic member 340 on the first housing 310. In the present embodiment, the elastic members 340 may be elastic sealing elements or springs, and the lock members 330 may be screws. Moreover, to make the alignment between the projection lens 320 and the first housing 310 during the process of assembling the projection lens 320 on the first housing 310 more easier, the first combination part 312 further has a plurality of alignment tenons 312d, and each connection part 323 further has a plurality of alignment holes 323b, and each alignment tenon 312d is respectively inserted into one of the corresponding alignment holes 323b.

Referring to FIG. 3, FIG. 4B and FIG. 5, the aforementioned first housing 310 may further have a second combination part 314 which has a second datum plane 314a, and a display device 410 is suitable for leaning against the second datum plane 314a. In particular, the second datum plane 314a is formed by the top surfaces of a plurality of second ribs 314b formed on the second combination part 314, and the display device 410 is suitable for leaning against the top surfaces of the second ribs 314b.

As described above, the normal vector of the active surface 412 of the display device 410 needs to be parallel to the optical axis of the projection lens 320 for maintaining a good image quality. However, the heights of the first ribs 312c used for the connection part 323 leaning against may not be identical to each other due to the manufacturing tolerance, and the heights of the second ribs 314b may not be identical to each other due to the manufacturing tolerance, and thus, the normal vector of the active surface 412 of the display device 410 may not perfectly be parallel to the optical axis of the projection lens 320. Moreover, accumulation of the tolerance is inevitable during the process of fixing the projection lens 320 and the display device 410 on the first housing 310. Thus, in the present embodiment, an elastic member 340 is disposed between each connection part 323 and the first combination part 312, such that the tilt angle of the projection lens 320 is adjusted by adjusting the tension of the lock members 330, and thus the optical axis of the projection lens 320 is rendered substantially parallel to the normal vector of the active surface 412 of the display device 410. The method of adjusting the tilt angle of the projection lens 320 will be described below.

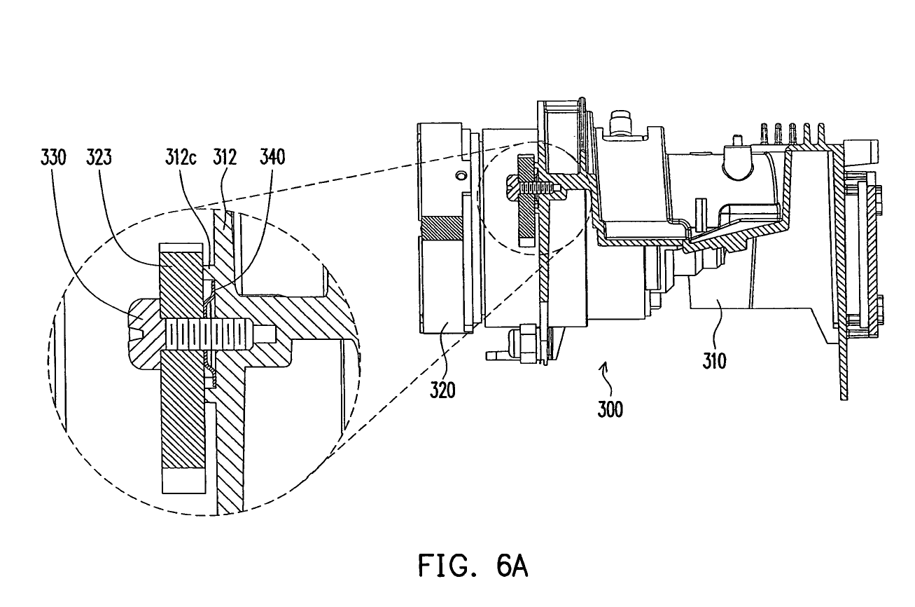

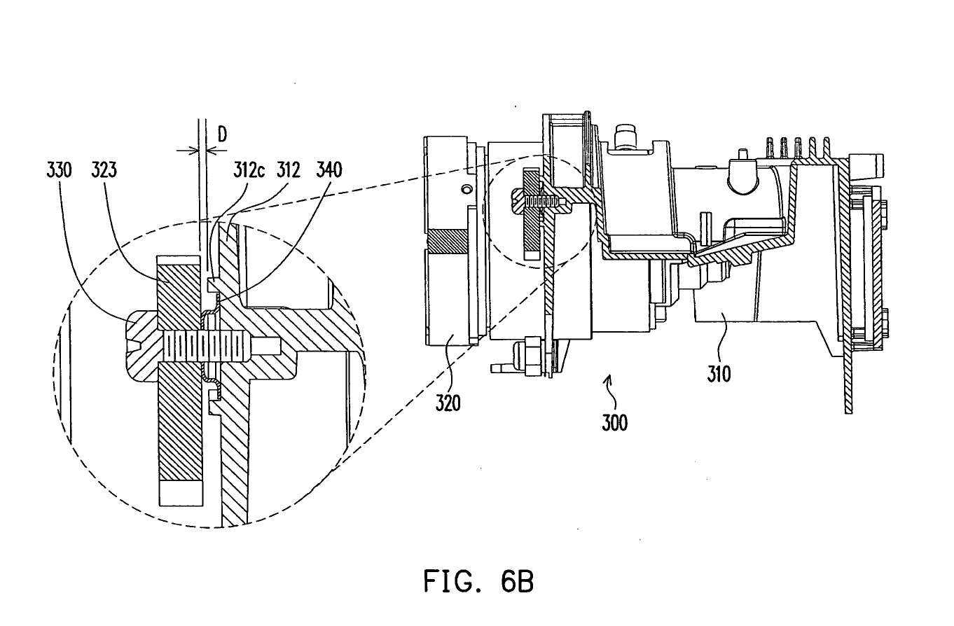

Referring to FIG. 6A, in the present embodiment, when the projection lens 320 is assembled to the first housing 310, the connection parts 323 of the projection lens 320 are leaned against the top surfaces of the first ribs 312c of the first housing 310 by locking the lock members 330 tightly, and the elastic members 340 are compressed by the connection parts 323 and the first combination part 312.

Referring to FIG. 6B, if the optical axis of the projection lens 320 is not parallel to the normal vector of the active surface 412 (shown as FIG. 3) of the display device 410, which causes poor image quality, the situation may be adjusted by loosening at least some of the lock members 330. In particular, when one of the lock members 330 is loosened and has a displacement with a distance D, a restoring force of the compressed elastic member 340 pushes the connection part 323 towards the lock member 330, and make the connection part 323 lean against the lock member 330. As the connection part 323 being pushed towards the lock members 330, the projection lens 320 tilts at a certain angle, and the optical axis of the projection lens 320 tilts accordingly. Thus, the tilt angle of the optical axis of the projection lens 320 is adjusted by adjusting the tension of the lock members 330, such that the optical axis of the projection lens 320 is parallel to the normal vector of the active surface 412 of the display device 410, so as to reduce the problems of poor focusing quality and improve image quality. In addition, since the tilt angle of the projection lens 320 is adjustable, the stringent requirement of the manufacturing precision of the first housing 310 and the projection lens 320 is relaxed such that the production yield is improved and the production cost is reduced.

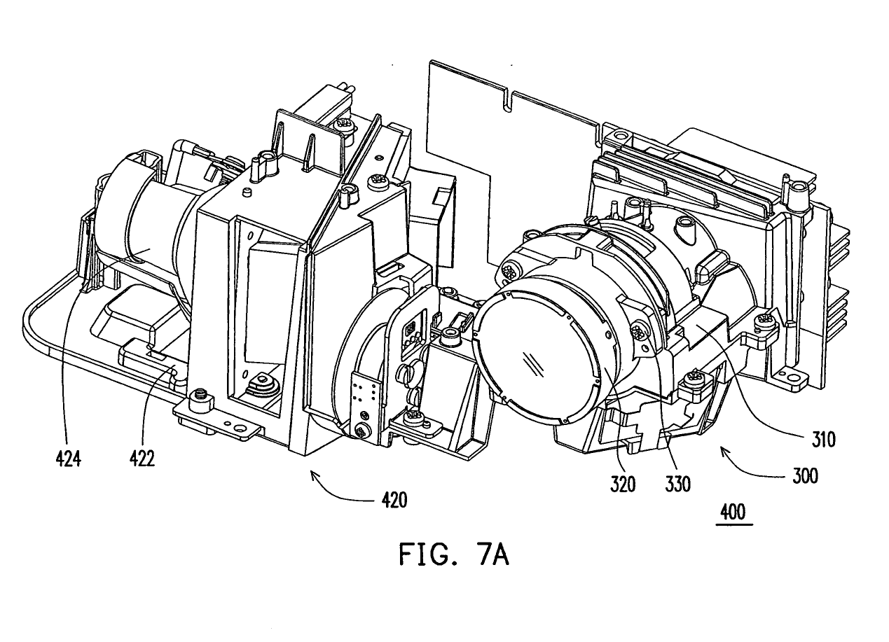

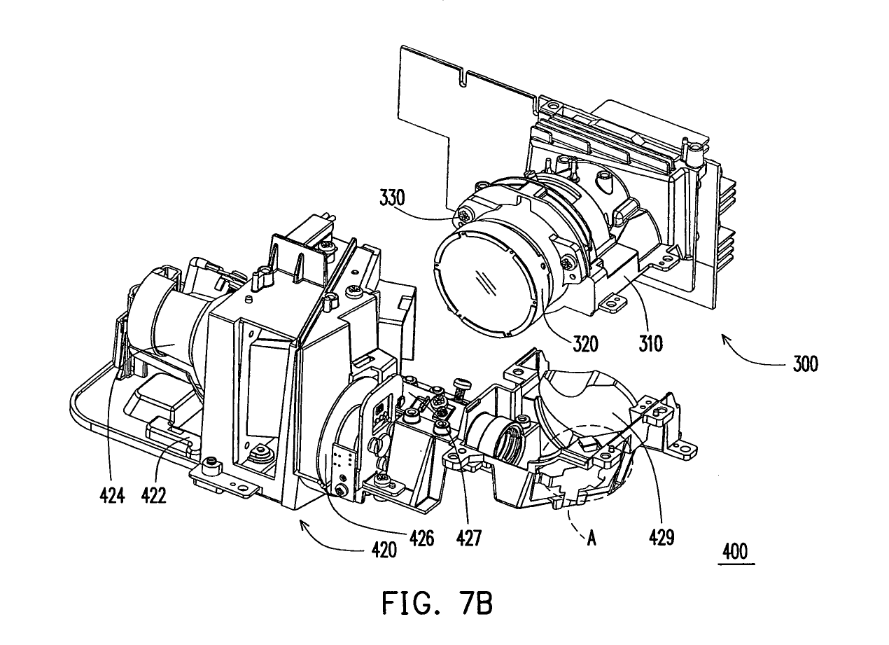

Referring to FIG. 7A and FIG. 7B, an projection device 400 according to one embodiment of the present invention includes an illumination module 420, the aforementioned imaging module 300 and the aforementioned display device 410. It is noticeable that the display device 410 is not shown in FIG. 7A and FIG. 7B, and the display device 410 is shown in FIG. 3. Moreover, the illumination module 420 includes a second housing 422 combined with the first housing 310 and a light source 424 fixed on the second housing 422. The light source 424 is capable of providing an illumination beam which passes through the optical components such as a color wheel 426, a light integration rod 427 etc., and the illumination beam is reflected to the lens 429 by a reflector (not shown) disposed at the corner A of the second housing 422. The lens 429 focuses the illumination beam on the display device 410. In addition, the display device 410 is, for example a reflective light valve (such as digital micro-mirror device) which converts the illumination beam into an image beam and reflects the image beam to the projection lens 320. The projection lens 320 projects the image beam to a screen (not shown) to form an image.

In the present embodiment, when the optical axis of the projection lens 320 is not parallel to the normal vector of the active surface 412 of the display device 410, the situation can be adjusted by adjusting the tension of the lock members 330, such that the poor focusing quality is improved. Thus, the projection lens 400 of the present embodiment has a good image quality.

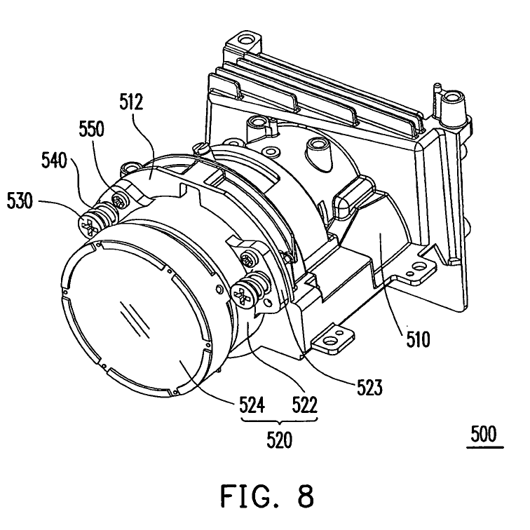

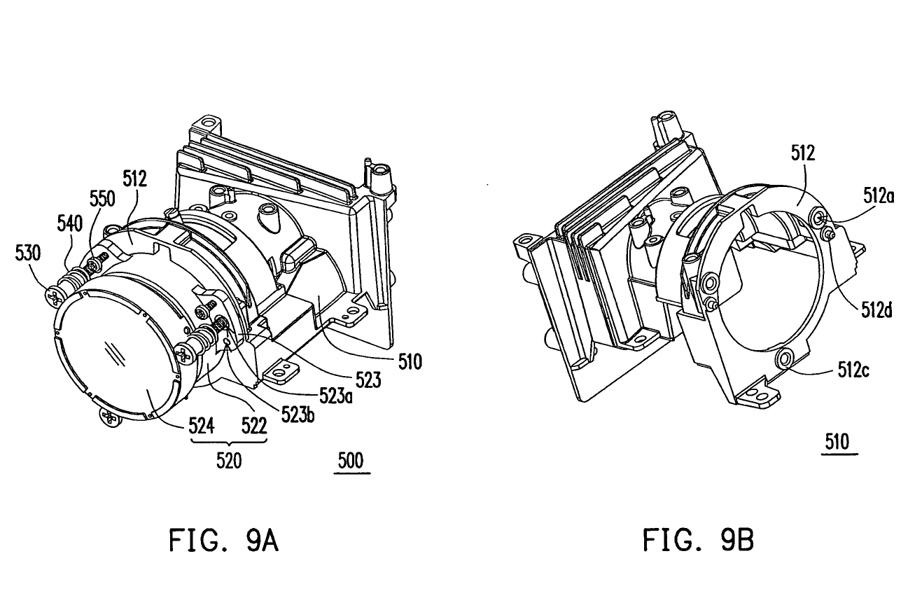

Referring to FIG. 8, FIG. 9A, and FIG. 9B, an imaging module 500 according to another embodiment of the present invention includes a first housing 510, a projection lens 520, a plurality of first lock members 530, a plurality of elastic members 540 and a plurality of second lock members 550, and the first lock members 530 are used for locking the projection lens 520 and the elastic members 540 on the first housing 510.

As described above, the first housing 510 has a first combination part 512, and the first combination part 512 has a plurality of first lock holes 512a. A plurality of first ribs 512c is formed on the first combination part 512, and each first rib 512c is disposed around one of the first lock holes 512a. Moreover, in the present embodiment, the shape of the first combination part 512 is substantially a ring, and an angle between two adjacent first lock holes 512a is approximately 120 degree. In addition, the projection lens 520 has a lens barrel 522 and at least one lens 524 disposed inside the lens barrel 522, and the lens barrel 522 has a plurality of connection parts 523 extending outward. Each connection part 523 has a second lock hole 523a, and each second lock hole 523a respectively corresponds to one of the first lock holes 512a

Each aforementioned first lock member 530 is inserted into the corresponding second lock hole 523a and first lock hole 512a, and is locked in the corresponding first lock hole 512a. Each first lock member 530 is correspondingly inserted into an elastic member 540, and each elastic member 540 is leaned against one end of the corresponding first lock member 530 and the corresponding connection part 523. In addition, each connection part 523 further comprises a third lock hole (not shown), and each second lock member 550 is correspondingly inserted into a third lock hole, and each second lock member 550 is leaned against the first combination part 512. In the present embodiment, the elastic members 540 may be springs, the first lock members 530 and the second lock members 550 may be screws, the first lock holes 512a and the third lock holes may be thread holes, the second lock holes 523a may be through holes. Moreover, to make the alignment between the projection lens 520 and the first housing 510 during the process of assembling the projection lens 520 on the first housing 510 more easier, the first combination part 512 further has a plurality of alignment tenons 512d, and each connection part 523 further has a plurality of alignment holes 523b, and each alignment tenon 512d is correspondingly inserted into an alignment holes 523b.

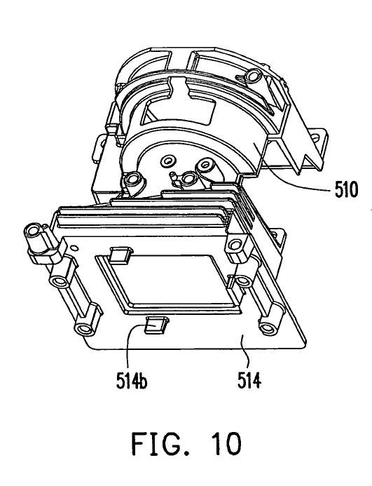

FIG. 10 is a perspective view of the first housing of FIG. 8 in another visual angle. Referring to FIG. 8, FIG. 9B and FIG. 10, the aforementioned first housing 510 further has a second combination part 514, the second combination part 514 has a second datum plane and a display device (not shown) is suitable for leaning against the second datum plane. In particular, the second datum plane 314a is formed by the top surfaces of a plurality of second ribs 514b formed on the second combination part 514, and a display device (not labelled) is suitable for leaning against the top surfaces of the second ribs 514b.

As described above, the normal vector of an active surface of the display device needs to be parallel to the optical axis of the projection lens 520 for maintaining a good image quality. However, heights of the first ribs 512c may not be identical to each other due to the machining tolerance, and heights of the second ribs 514b may also not be identical to each other due to the machining tolerance, and thus, the normal vector of the active surface of the display device may not be perfectly parallel to the optical axis of the projection lens 520. Moreover, accumulation of the tolerance is inevitable during the process of fixing the projection lens 520 and the display device on the first housing 510. Thus, in the present embodiment, an elastic member 540 is disposed between one end of each first lock member 530 and the corresponding connection part 523, and the second lock members 550 are leaned against the first combination part 512, such that the optical axis of the projection lens 520 get to be parallel to the normal vector of the active surface of the display device by adjusting the tilt angle of the projection lens 520 by turning the second lock members 550 in a clockwise or anticlockwise direction. The method of adjusting the tilt angle of the projection lens 520 will be described below.

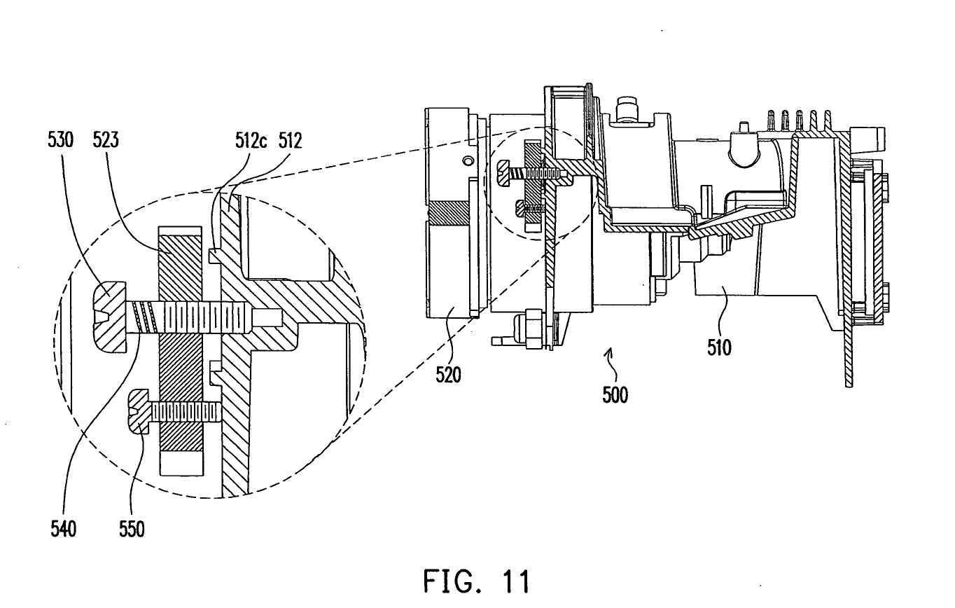

Referring to FIG. 11, in the present embodiment, when the projection lens 520 is assembled to the first housing 510, each connection part 523 of the projection lens 520 is leaned against the top surfaces of the first ribs 512c of the first housing 510 by locking each lock member 530 tightly. Moreover, the second lock members 550 are leaned against the first combination part 512. If the optical axis of the projection lens 520 is not parallel to the normal vector of the active surface of the display device, which causes poor image quality, the situation may be adjusted by turning at least some of the second lock members 550 in the clockwise or anticlockwise direction. In particular, when one of the second lock members 550 being screwed towards the first combination part 512, the first combination part 512 holds back the movement of the second lock member 550, thus the connection part 523 moves along a direction away from the first combination part 512, which causes the projection lens 520 to tilt at a certain angle, and the optical axis of the projection lens 520 tilts accordingly. Thus, the optical axis of the projection lens 520 is rendered parallel to the normal vector of the active surface of the display device by adjusting the tilt angle of the optical axis of the projection lens 520 by turning the second lock members 550 in the clockwise or anticlockwise direction, such that the problems of poor focusing quality and poor image quality is settled. In addition, since the tilt angle of the projection lens 520 is adjustable, the strict requirement of the machining precision of the first housing 510 and the projection lens 520 is relaxed such that the production yield is improved and the production cost is reduced. Moreover, the imaging module 500 of the present embodiment may be applied to the projection device 400 of FIG. 7A.

In summary, the present invention has at least the following advantages.

1. In the first imaging module of the present invention, the elastic members are disposed between each connection part of the lens barrel and the first combination part of the first housing, thus, by adjusting the tension of the lock members, the tilt angle of the projection lens is adjusted so as to substantially render the optical axis of the projection lens parallel to the normal vector of an active surface of the display device so that the image quality is improved.

2. In the second imaging module of the present invention, the second lock members are leant against the first combination part, thus, by turning the second lock members in a clockwise or anticlockwise directions, the optical axis of the projection lens is substantially rendered parallel to the normal vector of an active surface of the display device so that the image quality is improved.

3. Since the tilt angle of the projection lens is adjustable, the stringent requirement of the machining precision of the first housing and the projection lens is relaxed and the production throughput is increased and the production cost is reduced.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An imaging module, comprising:
a first housing, having a first combination part, the first combination part comprising a plurality of first lock holes;
a projection lens, comprising:
a lens barrel, having a plurality of connection parts extending outward, each connection part having a second lock hole, and each second lock hole respectively corresponding to one of the first lock holes; and
at least one lens, disposed inside the lens barrel;
a plurality of elastic members, disposed between each connection part and the first combination part, each elastic member having a first surface and a second surface opposite to the first surface, the first surface leant against the connection part, the second surface leant against the first combination part, the first surfaces forming a first datum plane, and the connection parts leant against the first datum plane; and
a plurality of lock members, each lock member inserted into the corresponding second lock hole and first lock hole and the elastic member between the corresponding second lock hole and first lock hole.

2. The imaging module as claimed in claim 1, wherein the first combination part further comprises a plurality of alignment tenons, each connection part further comprises a plurality of alignment holes, and each alignment tenon is respectively inserted into one of the alignment holes.

3. The imaging module as claimed in claim 1, wherein the first housing further comprises a second combination part, the second combination part has a second datum plane, and a display device is suitable for leaning against the second datum plane.

4. The imaging module as claimed in claim 1, wherein the elastic members are elastic sealing elements or springs.

5. The imaging module as claimed in claim 1, wherein the numbers of the connection parts and the elastic members are respectively three, and an angle between two adjacent connection parts is 120 degree.

6. An imaging module, comprising:
a first housing, having a first combination part, and the first combination part having a first datum plane and a plurality of first lock holes;
a projection lens, comprising:
a lens barrel, having a plurality of connection parts extending outward, each connection part having a second lock hole and a third lock hole, and each second lock hole respectively corresponding to one of the first lock holes; and
at least one lens, disposed inside the lens barrel;
a plurality of first lock members, each first lock member inserted into the corresponding second lock hole and first lock hole, and locked in the corresponding first lock hole;
a plurality of elastic members, the first lock members respectively inserted into the elastic members, and each elastic member leant against one end of the corresponding first lock member and the corresponding connection part; and
a plurality of second lock members, respectively inserted into the third lock members, each second lock member leant against the first combination part.

7. The imaging module as claimed in claim 6, wherein the first combination part further comprises a plurality of alignment tenons, each connection part further comprises a plurality of alignment holes, and each alignment tenon is respectively inserted into one of the alignment holes.

8. The imaging module as claimed in claim 6, wherein the first housing further comprises a second combination part, the second combination part has a second datum plane, and a display device is suitable for leaning against the second datum plane.

9. The imaging module as claimed in claim 6, wherein the elastic members are springs.
